(19) United States
(12) Patent Application Publication
(10) Pub. No.: US 2017/0352443 A1
(43) Pub. Date: Dec. 7, 2017

(54) UPGRADING POWER OUTPUT OF PREVIOUSLY-DEPLOYED NUCLEAR POWER PLANTS

(71) Applicant: Advanced Reactor Concepts LLC, Chevy Chase, MD (US)

(72) Inventor: Leon C. Walters, Idaho Falls, ID (US)

(21) Appl. No.: 15/614,536

(22) Filed: Jun. 5, 2017

Related U.S. Application Data
(60) Provisional application No. 62/345,147, filed on Jun. 3, 2016.

(51) Int. Cl. G21D 1/02; G21C 15/02; G21C 15/18; G21D 1/04

(52) U.S. Cl. CPC G21D 1/02; G21D 1/04; G21C 15/02; G21C 15/18; G21Y 2002/20

(57) ABSTRACT

Systems and methods for upgrading power output of previously-deployed nuclear power plants are described. Systems and methods may include a base nuclear power plant with a predetermined base power output rating and a predetermined base whole core refueling interval. Systems and methods may also include a power upgrade kit for increasing the base power output rating from the base power output rating to an increased power output rating without a change in fuel charge, reactor structures, or civil structures.

### FIELD OF THE INVENTION

The present invention relates to systems and methods for nuclear power plants and more specifically for systems and methods for increasing power output of previously-deployed nuclear power plants partway through their lifetime by use of a power upgrade kit.

### BACKGROUND OF THE INVENTION

Small Modular Reactors (SMRs) offer practical and economic advantages for nations that are undergoing rapid economic growth with concomitant rapid demand growth for electrical power. As contrasted to deployment of gigawatt-sized traditional light water reactors (LWRs), adding supply capacity in smaller increments of shorter construction intervals may more closely follow the growth in demand and smooth out capital expenditures. Additionally, the nation's electrical grid may be small, fragmented and generally undeveloped initially and therefore unable to accommodate a large-capacity plant. However, by prelicensing a site for multiple SMRs, they can be added sequentially as demand and grid capacity grow.

Thus, most SMR deployment scenarios envision multiple standalone SMR plants that are co-sited over time on a common site—but with limited sharing of facilities—confined to cooling water supply infrastructure, switchyard, railroad siding, administrative building and perhaps spent fuel storage facilities. In these scenarios, each SMR plant has its own reactor and Balance of Plant (BOP), is housed in its own civil structures (containment and shield building) and has its own refueling apparatus. Therefore, as compared with deployment of a large traditional LWR, the SMR strategy (excepting the shared site) forgoes economy of scale derived from large civil structures and large steam cycle energy converter equipment.

Thus, needs exist for SMR deployment sequences based on systems of construction allowing for, among other things, upgrading the power output of already-deployed SMRs rather than the installation of an entirely new SMR.

### DETAILED DESCRIPTION OF THE PREFERRED EMBODIMENTS

Systems and methods are described for using various tools and procedures for upgrading power output of previously-deployed power plants.

The systems and methods described herein may be used to upgrade an existing power plant, such as a small modular reactor (SMR). Systems and methods described herein may also be used to construct and/or operate an entirely new SMR. As an illustrative example, the present disclosure discusses upgrading power output of a previously-deployed nuclear power plant by reference to an ARC-100 small modular reactor (Advanced Reactor Concepts, LLC) with long refueling interval. This is for discussion purposes only and the present disclosure is not limited to only use with ARC-100 reactors and plants. It is noted that any reactor and plant with adequate space and potentially with upgrade as a design goal may incorporate some or all of the concepts described herein to upgrade power output of a previously-deployed nuclear power plant.

Certain embodiments may recapture at least a portion of the forgone economy of scale as discussed in the Background of the Invention. Certain embodiments may enable a previously-deployed power plant owner to increase, such as for example double, the plant's power output part way through life without changing the fuel charge nor the vessel, containment and shield building. The power output increase may be achieved by installation and operation of a power upgrade kit. The power upgrade kit may include an additional energy converter and an additional intermediate heat transport loop. The power upgrade kit may also include other replaceable in-vessel heat transport components. Thereafter, the reactor may be run at an increased power density on the original fuel charge and the discharge burnup would be reached sooner. In a certain embodiment, the reactor may be run at double the initial power density on the fuel charge and the discharge burnup would be reached sooner.

Embodiments of the present invention may be modification of a previously-deployed power plant configuration, such as, for example, the ARC-100 reactor described in U.S. Pat. Nos. 8,767,902 and 9,640,283, which are incorporated by reference herein in their entirety. In general, ARC-100 may be described as a sodium cooled, metal alloy fueled fast neutron spectrum reactor of 260 MWth rating that drives an energy conversion portion, such as a super-critical CO₂ Brayton cycle energy converter producing about 100 MWe of electricity and about 160 MWth of cogeneration heat. ARC-100 may operate at low specific power (such as approximately 12.7 kwth/kg fuel) so as to attain a very long (approximately 20 year) whole core refueling interval.

An energy conversion portion may comprise one or more heat exchangers, one or more secondary heat exchangers that can interact with a heat exchanger contained within a core portion. An energy conversion portion may comprise one or more turbines (such as, for example, one or more gas turbines), one or more electrical generators, and/or one or more compressors. The energy conversion portion can be configured to interact with a core of an SMR to convert heat energy into electrical energy and/or use waste heat for cogeneration applications. As used herein, Brayton cycle energy conversion can be substituted for other types of energy conversion, for example Rankine energy conversion in embodiments described herein. The skilled artisan would readily envisage how to apply, add, and/or substitute the types of energy conversion to any of the embodiments described herein and would readily understood that a reference to the Brayton cycle may also refer to a Rankine cycle and vice versa. The meanings of these terms will be immediately clear to the skilled artisan based upon the context in which they are used herein.

Previously-deployed power plants may achieve power output upgrades using the systems and methods as described herein. In certain embodiments, modifications may be made to a deck, a Redan and one or more intermediate sodium loops. As an example, embodiments of ARC-100's features and design parameters permit at least a factor of two power uprate at any time during its 20 year burn cycle without requiring a new fuel loading nor any change in reactor design or safety strategy nor in vessel size and size of nuclear safety grade civil structures, i.e., silo, containment and shield building.

Certain embodiments may allow a plant owner to start with a 100 MWe plant and to upgrade to 200 MWe when needed without the need to construct a new plant. Certain embodiments described herein can be used to construct and/or operate a new plant that can produce about 200 MWe.

### Description of a Deployment Sequence

Initial deployment of an upgradeable reactor may be in a base power configuration. The base power configuration may include a predetermined power output with a predetermined amount of reject heat. As an example, an upgradeable ARC-100 reactor, referred to herein as “ARC-100/200”, would initially be in its 100 MWe configuration. BOP for the ARC-100/200 may have a standard 100 MWe Brayton cycle and forced draft cooling tower array and/or switch yard. Sodium cooling is described herein, but other types of cooling systems may also be employed in various embodiments, such as, for example, a Rankine cycle as described herein. If desired, ARC-100/200 may have cogeneration equipment utilizing about 160 MWth of Brayton cycle reject heat. In certain embodiments, cogeneration equipment may be employed to provide up to about 100 MWth, about 150 MWth, about 75 MWth, and ranges therebetween as would be immediately understood and envisaged by the skilled artisan.

In certain embodiments, a BOP may be driven by one or more sodium intermediate loops. In some embodiments, a single sodium intermediate loop rated at about 260 MWth. Some embodiments may also comprise two sodium intermediate loops configured to produce about 130 MWth each. Certain embodiments may comprise an intermediate sodium loop (or steam loop in the case of a Rankine cycle) that could produce up to about 50 MWth, about 100 MWth, about 150 MWth, about 175 MWth, about 200 MWth, about 250 MWth, about 260 MWth, and ranges therebetween. The numbers provided in this disclosure are for illustration purposes only and are not intended to be limiting. It should be noted that power output, reject heat, etc. may vary for different types and varieties of nuclear power plants, and the skilled artisan would understand such variances and controls and how to produce the desired output when viewing the disclosure contained herein.

Certain embodiments may further comprise civil structures. Civil structures may comprise a silo, shield building, and/or seismic isolation components. Certain embodiments may comprise a nuclear safety zone for the site. A site may comprise a reactor, guard house, security fence and/or maintenance shop. In certain embodiments, civil structures and/or safety features may be present from the initially-deployed power plant.

A vessel comprised in embodiments described herein may be of a size that the skilled artisan would be familiar with and could be sized to hold a standard fuel charge, such as for example, the sizes described herein and incorporated by reference. In the example of an ARC-100/200 reactor, a fuel charge may be approximately 20 tonne fuel charge. In certain embodiments, a fuel charge may be up to about 20 tonnes and ranges therebetween. Certain embodiments may comprise a fuel charge of 10-20 tonnes, 20-30 tonnes, 30-50 tonnes, and ranges therebetween.

Embodiments comprising a deck, Redan, and/or permanent shielding of a reactor, such as an upgradeable reactor described herein, may be modified in anticipation of upgrade. A deck and/or Redan may have one, two, or more penetrations sized to accommodate one, two or more internal heat exchangers (IHXs) of a predetermined capacity. In certain embodiments, a predetermined capacity may be twice the base capacity of the IHXs of the reactor. In an example of an ARC-100/200, each IHX may have a capacity of approximately 260 MWth each. Some embodiments may also comprise IHXs with a capacity of about 130 MWth each. Certain embodiments may comprise IHXs with a capacity of up to about 50 MWth, 100 MWth, 150 MWth, 175 MWth, 200 MWth, 250 MWth, 260 MWth, and ranges therebetween. Certain embodiments may also comprise a dummy IHX of identical dimensions to a first IHX, but may serve to block coolant flow, such as sodium flow in a sodium cooling system. A deck and/or Redan may have penetrations to accommodate one, two, three, four or more pumps, each which may be twice the base pump rating or the same as the base pump rating. Certain embodiments may hold dummy pumps that may block inlet pipes to a core coolant inlet plenum. Systems described herein may comprise, one, two, three, four, or more dummy pumps. A deck and/or Redan may have accommodations for two or more additional direct reactor auxiliary cooling (DRAC) heat exchangers, but the accommodations may be blocked with one or more dummy DRACs. In-vessel permanent shielding may be standard or non-standard as compared to base in-vessel permanent shielding to shield against a more intense neutron source at higher specific power. In-vessel permanent shielding may be rated for operations of a upgraded power output produced by embodiments as described herein. In the example of an ARC-100/200 reactor, in-vessel permanent shielding may be configured for operations at 200 MWe conditions instead of 100 MWe.

A vessel may be housed in civil structures (such as for example, silo, containment shield building and seismic isolation). Safety systems, such as standard safety related systems may be installed in a shield building. Safety systems may comprise a sodium cleanup system, cover gas cleanup system, scram system, plant condition monitoring and control systems, alarm systems, security features, and/or evacuation systems.

The site may be licensed for operations at least at the upgraded power output, although the license may also be for less than the total power output capability.

In an embodiment, after startup in the base configuration, a reactor fuel charge may be operated at a specific power based upon the plant configuration. A plant may deliver a base amount of electricity and a base amount of heat. In an example of an ARC-100/200 reactor, a base configuration may provide an ARC-100 value of about 12.7 Kw/kg fuel specific power, and a base configuration could deliver about 100 MWe of electricity and about 160 MWth of heat available for cogeneration missions. Certain embodiments may provide up to about 5, about 10, about 12, about 12.5, about 12.7, about 13 Kw/kg fuel specific power.

Sometime during the refueling interval before the fuel charge reached end of life, demand may have grown such that the plant owner needs to add fuel supply. The plant owner may have the option to either buy a whole new plant or to double the output from the plant already in operation. Embodiments described herein provide a solution for both options.

A power upgrade kit may be provided as described herein. In certain embodiments, a power upgrade kit may comprise: at least one duplicate cooling system, possibly including at least one additional IHX and associated intermediate loop piping, sodium inventory, and equipment set; at least two primary pumps; and at least two DRACS systems. The kit may also include a duplicate energy convertor system.

In an example of an ARC-100/200 reactor, a power upgrade kit may include: one or more duplicate energy conversion systems, such as 100 MWe Brayton cycle, plus one or more associated cooling tower arrays; one 260 MWth IHX and associated intermediate loop piping, sodium inventory, and equipment set; two primary pumps; and two DRACS systems. In certain embodiments, these outputs may be altered as described herein.

In certain embodiments, BOP equipment may be installed and/or the switchyard may be upsized while continuing operations. In certain embodiments, BOP is configured without the necessity for any nuclear safety function and may be non-safety grade so that a BOP zone of the site can be openly accessible to non-cleared contractors.

In certain embodiments, after upgrading and installing equipment in the BOP, the reactor may be shut down and the primary sodium pool may be cooled down to refueling temperature. The intermediate sodium loop may be drained into its heated drain tank. The replaceable in-vessel heat transport components may then be installed, e.g., by replacing dummy components. Piping runs for a second loop to a second energy converter cycle in the BOP may be installed.

After refilling two or more loops with sodium, the reactor may be returned to a predetermined power output with a minimum of startup tests and a minimum of relicensing activity, meaning that confirmatory testing and regulatory review indicate that the installation of new equipment followed required standards. By prelicensing the upgraded power configuration, post uprate licensing interactions may be confined to confirmation that the new installations in the nuclear zone of the plant had been properly completed.

Following an upgrade of a power plant as described herein, the plant power output could be up to two or more times the base level of electricity and up to two or more times the base level of cogeneration heat by running the fuel at twice the former specific power. In the example of an ARC-100/200 reactor, the plant power output may be up to 200 MWe or more of electricity and up to 320 MWth or more of cogeneration heat, and ranges therebetween. The specific power may be, for example, approximately 25.4 kw/kg fuel (which could consume the fuel at about twice the former rate). The End of Life burnup limit on a fuel charge could be reached sooner in certain embodiments. In the example of an ARC-100/200 reactor, a burnup limit on the fuel charge could be reached sooner than approximately 20 years.

In certain embodiments, with two energy conversion systems as described herein, each driven by its own loop from the reactor, each energy converter system may be operated at a different power from the other. In certain embodiments, reactor features of passive load-follow may be retained as discussed herein. Similarly, the safety posture of the plant may not be degraded in any way, by the process, as discussed herein.

As the ARC-100 in-vessel heat transport equipment is configured to be replaceable and since such replacements have been demonstrated on EBR-II and other sodium cooled reactors, for some embodiments, the shutdown for upgrading power may not exceed about 4 to 6 months.

When supporting a growing grid using an upgradeable power strategy as described herein, the time interval between construction and commencement of operation of completely new plants could increase by up to double or more, the refueling interval could be shortened, and dummy components from a first deployment may be saved for the next round of supply growth or sold to other plant operators.

The capital cost of the initial deployment at a base power output may not differ substantially from that of a standard base reactor because limited changes may be made, such as the penetrations in the top deck and Redan and the in-vessel shielding. The unexpected and superior advantages to the plant owner for the upgradeable strategy arise from permitting a start to power supply operations on an immature grid with a smaller initial capital investment, while still receiving benefits of economy of scale in the civil structure component of capital cost by later on increasing power output from the same power plant. Furthermore, BOP economy of scale is retained because a an energy conversion system, such as a Brayton cycle, may be small and modular. Costs may not reflect overpayment for vessel, containment and shield building for the base configuration because size and cost are determined not by heat transfer equipment size but rather by fuel handling considerations. In the example of an ARC-100/200 reactor, the size of vessel for ARC-100 fuel handling may already be big enough to accommodate 200 MW heat transport equipment (and in some embodiments, big enough to accommodate equipment capable of more than 200 MW heat transport).

The following sections of this disclosure describe use of the systems and methods described herein on an ARC-100 reactor configuration to create an ARC-100/200 reactor. As such, the systems and methods described herein may provide an increase in power output of one time, two times, three times, four times, or more.

### Design Modifications and Explanation

### Doubling Fuel Charge Burnup Rate and Halving the Refueling Interval

An example of ARC-100's fuel charge of approximately 20 tonnes of UZr metal alloy fuel enriched to less than approximately 20% may be operated at the average specific power of approximately 12.7 kwth/kg fuel to attain an approximately 20 year whole core refueling interval at an approximately 90% capacity factor. Alternatively, by operating at a specific power of the same or substantially similar pin lattice of fuel (approximately 25.4 kwth/kg fuel), reactor power output may be increased (e.g., doubled when driving twice as hard), but the fueling interval may decrease by half to approximately 10 years. In certain embodiments, increases in fuel input may have a linear correlation with the decrease in fueling interval. Specific power levels and their corresponding alterations would be understood by the skilled artisan in light of the present disclosure. Often, sodium cooled, metallic alloy fueled fast neutron spectrum reactors operate at up to approximately 120 kwth/kg fuel and attain peak discharge burnups of approximately 150 MWth-days/kg fuel with refueling intervals of approximately 2 or 3 years.

While the heat production of the fuel charge can be doubled by operating at double amplitude of baseline neutron flux, all heat transport provisions could be doubled and the energy converter equipment in the BOP could be doubled to produce approximately 200 MWe of electricity and approximately 320 MWth of heat.

### Doubling the Modular Energy Conversion Equipment

A supercritical CO₂ Brayton cycle rotating machinery equipment may be small and of very high power density, which may be desirable for certain embodiments as described herein. Recuperation heat exchangers, sodium to CO₂ heat exchangers, and CO₂ to cooling water heat exchangers may be high power density designs of printed circuit type. In certain embodiments, these may rely upon a modular fabrication process. Therefore, a method for doubling the rating of the energy conversion system capacity may be to add a second 100 MWe energy conversion system, such as a Brayton cycle unit.

### No Necessary Change in Vessel Size

An example of an ARC-100 vessel may be approximately 23 feet in diameter by approximately 54 feet high and approximately 2 inches thick. In certain embodiments, a vessel inner diameter (ID) may be between about 15-20 feet, about 20-25 feet, about 20-30 feet, about 30-40 feet, up to about 25 feet, and ranges therebetween. The height of a vessel is not particularly limited and may be between about 40-60 feet high, about 30-70 feet high, about 50-60 feet high, about 50-55 feet high, up to about 60 feet high, up to about 55 feet high, and ranges therebetween. The thickness of a vessel is not particularly limited and may be between about 1-3 inches thick, about 1-5 inches thick, up to about 3 inches thick, up to about 2 inches thick, and ranges therebetween. A vessel may house a core, at least one electromagnetic (EM) pumps, at least one IHX of approximately 130 MWth each and at least one DRACS heat exchanger. In an embodiment, a vessel may comprise a core, four EM pumps, two IHXs of about 130 MWth each and three DRACS heat exchangers. In certain embodiments, IHXs, pumps and up to three DRACS may be replaceable in-vessel components. The vessel may also house non-replaceable components such as a core barrel, permanent shielding, inlet plenum and grid plate, upper internal structure and a Redan structure that can separate a cold pool of primary sodium from a hot pool of sodium. Replaceable in-vessel heat transport components may penetrate the Redan and/or the deck that can seal the top of the vessel. Replaceable heat transport components may be supported by the deck.

The inner diameter and height of a vessel may be determined by fuel handling considerations. The height preferably allows for vertical withdrawal of fuel assemblies out of a core followed by in-vessel, horizontal fuel transport to a extraction port located at the core radial periphery. In certain embodiments, the fuel transport may occur while the fuel assemblies remain submerged in a primary sodium hot pool. In-vessel operations may be conducted by withdrawing and transporting fuel assemblies (e.g., seven at a time in 7-assembly clusters) by using, for example, a Pantograph machine mounted to an off-center rotating shield plug that can be situated in a vessel top deck. The offset distance and diameter of a rotating shield plug may be determined by an fuel transport process (such as a 7-assembly cluster handling) considerations, and these dimensions in turn may determine the ID of the vessel. The outer diameter (OD) of a core barrel (wherein a core barrel can comprise components of a core system) and the ID of a vessel may be used to determine the width of any annular space where replaceable heat transport components can be positioned. In certain embodiments, any annular space can be determined by fuel handling considerations. Such annular space from modified ARC-100 heat transport equipment can be adequate for modified ARC systems as described herein, and can, for example, accommodate the double sized components needed for at least 200 MWe operations.

### Provisions for Power Uprate in the Deck and Redan

There may be adequate space in any in-vessel annulus to at least double the size of the heat transport components, but the penetrations through the non-replaceable deck and Redan can be modified to handle both approximately 100 and 200 MWe configurations. One way this may be accomplished by providing penetrations through a deck and/or Redan to accommodate, for example, up to two IHXs of about 260 MWth rating, and operating the originally installed components of the system for approximately 100 MWe configuration, by using for example, one loop by blocking off the second loop with a dummy IHX component of identical or substantially identical dimensions. In certain embodiments, a dummy IHX may comprise only a shell containing no internal tubes and structures, which is advantageous because the dummy may be inexpensive compared to a non-dummy IHX. When modifying a former system as described herein to an approximately 200 MWe configuration, the dummy IHX may be withdrawn and replaced with a operable, non-dummy IHX.

A similar approach can be applied for primary pumps and any DRACS in-vessel heat exchangers. In embodiments comprising four pump positions, the four pump positions may accommodate components sized for approximately 200 MWe operation. In certain embodiments comprising four pump positions may comprise two positions that can be initially blocked off using dummy IHXs during operations of approximately 100 MWe output. In embodiments comprising DRACS, adding up to two more DRACS of the same rating may retain the degree of redundancy achieved by a previously operating approximately 100 MWe configuration. In certain embodiments, DRACS positions may be blocked by dummy DRACS. In certain embodiments, two DRACS positions can be blocked by dummy DRACS.

### No Necessary Change in Containment Size and No Necessary Change in Civil Structures

ARC-100 civil structures may comprise a silo and shield building that can be co-situated on a horizontal seismic isolation pad, and in some cases, share a common horizontal seismic isolation pad. A containment structure may comprise a guard vessel and a removable metal dome sized to be installed over a vessel deck. Together, a guard vessel and dome may totally surround a vessel. A vessel and guard vessel may be situated in a silo beneath a floor level of a shield building. In certain embodiments, a containment structure may comprise a guard vessel, a removable metal dome that can be installed over a vessel deck, a vessel comprising the vessel deck.

A function of a containment structure may be to mitigate release of radioactivity in the event that any severe accident has caused a vessel breach. The function of any civil structures may be to protect a vessel and a containment structure and all systems corresponding to nuclear safety external hazards, e.g., earthquakes, high winds, missiles, etc.

Traditional LWR plants require a large-volume, pressure-tight containment to mitigate release of radioactivity in the event of postulated severe accidents that release pressurized radioactive gas and aerosols from the primary system. The LWR containment must be of large volume to avoid unsustainably-high pressure. The shield building that encompasses it is therefore bigger still and must be robust, thereby requiring substantial construction commodities and cost.

The situation for ARC-100 is different and hence produces unexpected and superior results. Severe accidents all lead to a final state of in-vessel retention of radioactivity. A subcritical, passively-coolable debris bed of disrupted fuel may remain confined in an intact vessel with passive decay heat removal operation. The containment structure may never be subjected to high internal pressure, so any disrupted fuel may be of small volume.

As a result, for ARC-100, the dimensions of all civil structures may be determined not by containment size but rather by the space required for fuel handling operations as described herein. The diameter and depth of the silo may be determined by vessel dimensions. The height of the shield building above the deck of the vessel may be set by a requirement to withdraw fuel assemblies vertically out of the vessel into a cask. The space inside a shield building may be configured to accommodate any and all ancillary systems related to radioactivity safety. The below-grade silo and seismic isolation may help to provide protection against external hazards and to some degree may mitigate requirements on shield building ruggedness.

In certain embodiments, a power uprate may change nothing in the configuration and size of any civil structures. For example, modifications of previously installed systems as described herein may only modify or add components related to energy and/or heat generation such as, for example, components in a core portion and components in an energy conversion system. In such embodiments, the fuel assemblies and vessel sizes may be unchanged. In such embodiments, effects of external hazards may not change. In such embodiments, a radioactivity source comprising fission products and transuranics may have a term of fission products and transuranics may change only minimally, and as discussed herein, the outcome of postulated severe accidents may not change, so the size and configuration of the containment may not change. Given an unchanged containment size, the civil structures that surround and protect the reactor from external events may not change either.

### No Necessary Change in Cogeneration Opportunities

Cogeneration systems driven by an energy conversion system, such as a Brayton cycle, reject heat may be part of any non-nuclear safety grade BOP. In certain embodiments, nothing that happens in the BOP may negatively affect reactor safety.

When a second energy conversion system, corresponding heat rejection equipment, and corresponding intermediate sodium loop are installed for the power uprate as described herein, e.g., as a stand-alone second energy converter system, the cogeneration equipment on the original energy conversion system may be unaffected. This may be due to the passive decay heat removal having no dependence on BOP equipment.

Any mission critical cogeneration systems requiring an assured heat supply may be required to find a replacement source of heat during the period of reactor shutdown for power upgrade.

Doubling the Heat Removal from the Original Pin Lattice

ARC-100 may have a high fuel volume fraction that may enhance internal breeding. Even in light of a reduced coolant volume fraction and a long fuel pin, ARC-100 coolant pressure drop across a pin lattice may be maintained at a low value by use of large diameter pins (large hydraulic diameter) and low lattice power density. With a pin lattice pressure drop of about 35 psi, primary pumps may be sized at approximately 320 Kg/sec flow rate at less than approximately 110 psi. In certain embodiments, a pin lattice pressure drop may be between about 25-40 psi, about 30-40 psi, about 30-35 psi, 35-40 psi, up to about 40 psi, up to about 35 psi, and ranges therebetween. In certain embodiments, primary pumps may be sized for about 300-350 Kg/sec, about 250-350 Kg/sec, up to about 350 Kg/sec, wherein the primary pumps operate at corresponding pressures of between about 100-150 psi, about 100-120 psi, about 100-110 psi, up to about 120 psi, and ranges therebetween.

Embodiments doubling power density without changing pin lattice geometry, doubling heat removal can also be accomplished by a combination of increasing the temperature rise across the core from approximately 150° C. to approximately 200° C. while also increasing the coolant flow rate to approximately 7/4 of its initial value. This flow rate increase may be about 170% or about 180% of its initial value in certain embodiments. In certain embodiments, flow area through IHXs doubles when power is doubled and thus no increase in pressure drop may occur there. In some embodiments, a 200 MWe configuration may require four pumps of approximately 560 Kg/sec flow rate at approximately 110 psi head.

### Effects on Safety Performance

Changes in Margins and Feedbacks Affecting Passive Response to Anticipated Transient without Scram (ATWS) Events

In embodiments where the specific power is increased up to approximately 25.4 kwth/kg fuel, this value is still well below the value used in many metal fueled fast spectrum sodium cooled reactors that can attain excellent passive safety response.

By lowering the inlet temperature while increasing the coolant flow rate through the fuel lattice, the primary coolant outlet temperature may be unchanged. The margins to damaging coolant temperatures (e.g., sodium boiling and clad damage) may also remain the same as before.

The core pressure drop may increase as described above but remain in a feasible range.

Doubling the specific power may increase the temperature rise in the fuel pin above the temperature of the coolant and that may increase the value of the reactivity vested in that rise. Increasing the coolant temperature rise across the core, however, increases the reactivity vested in that rise so the ratio of Doppler to core radial expansion reactivity feedbacks ratio remains nearly constant and passive safety response remains nearly constant.

By retaining the coolant temperature margins the same as they were before the power uprate, and by retaining the passive safety reactivity feedbacks within the acceptable range, the passive safety response may be retained after the power uprate to the increased configuration.

### Additional DRACS Systems for Passive Removal of Increased Decay Heat Level

Decay heat may be released after reactor shutdown by the radioactive decay of fission product atoms formed before shutdown. In the short term, the rate of heat release may be dominated by fission products of short half-life, so the short term decay heat power level scales with pre-shutdown power level. Decay heat release may be increased when a reactor is upgraded to a higher output power. In an example of an ARC-100/200, decay heat release may be double the ARC-100 level when power is upgraded to 200 MWe.

An ARC-100 reactor may have at least one and up to three or more passive DRACS units for decay heat removal. These DRACS may continuously during operation, and at least one (and, at times, any two) may hold a post-shutdown cold pool temperature to about 435° C. (and can peak at approximately 2.5 hours after shutdown) and any one system may by itself hold a cold pool temperature to about 530° C. (and can peak at approximately 14 hours after shutdown). To maintain the same or similar performance at double power rating and so as to not degrade the degree of redundancy available in modified power output configurations, penetrations for one, two, or more DRACS heat exchangers of the same or substantially the same power rating may be provided in the deck and Redan. These may be blocked with dummy components, such as dummy DRACS as described above, when operating in a lower, power output.

### No Necessary Change in Passive Load Follow and Non Safety Grade BOP

A reactor site may be segregated into a nuclear zone and a balance of plant zone. A nuclear zone may comprise a core portion and an energy conversion system. In certain embodiments, a nuclear zone comprises only a core portion. In the example of an ARC-100/200, a site may be segregated into a nuclear zone and a BOP zone. All or some of any nuclear safety functions may be housed in a guarded, access-controlled nuclear zone. In some embodiments, no nuclear safety functions may be housed in a BOP zone. Decay heat removal may not rely on onsite or offsite electrical power from the BOP zone nor on the cooling water supply for energy conversion system (e.g., Brayton cycle) heat rejection or on any cogeneration system using energy conversion system (e.g., Brayton cycle) reject heat. As used herein, the terms energy conversion system and energy conversion portion may be used interchangeably and their meaning and scope would be immediately envisaged by the skilled artisan in light of the context in which they are used.

Moreover, it is not necessary that any signals to the reactor's control rod drives or the primary pump speed controllers may originate in the BOP zone. In some embodiments, the only channel for information flow (such as operation diagnostics and operating conditions data) from the BOP zone to the nuclear zone is through the return temperature and flow rate of the intermediate sodium loops. The skilled artisan would envisage how to rely on additional channels for information flow, if so desired.

In certain embodiments, a reactor may rely on its innate reactivity feedbacks to passively self-adjust power level to match the heat removed from the vessel through the intermediate sodium loops to the BOP zone. For example, the heat removed from the intermediate sodium loops by a Brayton cycle may chill return temperature carried back through the intermediate loop to the IHX. This may in turn chill primary sodium in a cold pool thus setting the coolant temperature at the core inlet. If the BOP had extracts less than a predetermined amount of heat, the intermediate loop return temperature may be higher than certain typical operating conditions, and the primary sodium exiting the IHX may therefore be higher than certain typical operating conditions and the inlet coolant temperature to the core may be higher than certain typical operating conditions. This can decrease reactivity, which can cause reactor power to decrease. Power level may decrease and send less heat to the BOP through the intermediate loops. Power output may stabilize when reactivity goes back to zero, which may happen when the rate of heat addition to the intermediate loops matches the rate of heat removed by the BOP.

Whereas an energy conversion system (e.g., Brayton cycle) may be actively controlled to meet grid demand, the reactor itself may not be actively controlled by control rod movement. In certain embodiments, active control can comprise automated control systems such as programmable logic controllers (PLCs), human machine interfaces (HMIs), and other process control equipment generally known to the skilled artisan. As described herein, systems described herein may load follow the BOP heat demand communicated to it through any intermediate loops passively and without any control rod movements. Certain embodiments may rely on control rod movements and other active control processes in conjunction or apart from passive communication via any intermediate loops.

The values of any intermediate sodium loop flow rates and return temperatures may be bounded by physical phenomena such as zero flow or pump cavitation and by sodium freezing. The reactivity feedback parameter values for ARC-100 can be such that the reactor's passive safety response may maintain the reactor within safe conditions for the full range of physically-attainable intermediate loop conditions, and whether the scram system performs it's function or not.

The BOP zone may not only perform no safety function itself, but may also introduce no damaging accident initiators into the nuclear zone. The BOP zone may be designed, built and operated to industrial standards or to exceed industrial standards.

### No Diminishment of Severe Accident Performance

Severe accident performance rests on (1) size and character of the source term of radiotoxicity contained in the reactor, (2) scope and frequency of accident initiator events—both internal and external, and (3) phenomenology of response to each initiator.

When power is upgraded, it may not change the spectrum nor frequency of external initiators. Nor is it necessary to change the degree of protection provided by the civil structures. The BOP may retain its non-safety grade status in which BOP events cannot communicate any damage—resulting initiators to the reactor zone.

In some embodiments, the fuel charge may not change for modifications as described herein and the maximal fission product and transuranic mass burden may not change significantly because discharge burnup remains unchanged. So the source term (maximal value) remains significantly unchanged. The source term may adjust somewhat as the increased flux changes the burnup to natural decay destruction ratio for each isotope.

For ARC-100, the full spectrum of internal design basis category initiators may produce no fuel damage. Then, the Anticipated Transients Without Scram (ATWS) beyond design basis category of initiating events may also lead to no fuel damage owing to ARC-100's passive safety response features.

Postulated hypothetical initiators that may cause fuel disruption may lead to an end state of in-vessel retention of radioactivity and at worst a debris bed of disrupted fuel that is both subcritical and coolable by natural circulation. This outcome may rest on the phenomenology of metallic fuel melting and fission gas driven fuel dispersal, occurring at low values of energy deposition. For power-rising transients, the fuel melts, clad ruptures and sodium boils all nearly simultaneously. The molten fuel can be dispersed by the driving force of high pressure fission gas contained in the fuel morphology. This early fuel dispersal, when combined with incoherence in time of rupture for pins of differing initial power density, may preclude coherent widespread sodium boiling sufficient for ever-reaching super prompt critical conditions capable of producing vessel-rupturing levels of energy release. With no vessel rupture, the post-accident configuration of core and any debris that was formed may have primary sodium available to carry decay heat to the DRACS units for passive rejection to the atmosphere. And lastly, unlike oxide-fueled reactors, ARC-100's chemically reducing environment can retain Iodine and Cesium trapped in fuel and coolant rather than existing in mobile gaseous and aerosol physical states.

Doubling the fuel specific power rating does not alter this demonstrated severe accident response phenomenology for ARC-100. In fact, doubling specific power may actually bring the reactor nearer to the test conditions used in the TREAT testing that established this understanding of severe accident phenomenology.

Given no degradation of accident consequences or frequencies, the containment structure need not be changed and as a result all the civil structures sizing and design ratings can remain unchanged even as power output is doubled.

For ARC-100, the out-of-vessel fuel handling hazards may occur only once every 20 years and only over a several week period of fuel handling operations. The time at risk for ARC-100 is small compared with reactors that refuel yearly or biannually.

When plant power rating is doubled, the refueling interval may drop to about once every 10 years and the fuel heat load may be increased, but the time at risk remains much reduced from that of traditional plants.

### EXAMPLES

The following are examples for illustrative purposes only.

In certain embodiments, a prelicensed, standardized-design SMR power plant may be rated at approximately 100 MWe with an approximately 20 year whole core refueling interval. The power plant may be uprated in power output to approximately 200 MWe or more partway through its fuel burnup cycle. The uprating may be produced by installation of a Power Uprate Kit of equipment including, but not limited to, an additional energy converter system, an additional heat transport loop, and additional primary pumps and passive decay heat removal heat exchangers. In certain embodiments, a power uprate kit (which may be referred to simply as a kit herein) may comprise at least one additional energy converter system, at least one additional heat transport loop, at least one additional primary pumps, and at least one passive decay heat removal heat exchangers. Certain kit embodiments may also comprise two, three, or more of these. In some embodiments a kit can be installed without adding any additional fuel charge, reactor structures, and/or civil structures. Thus, the uprating described herein may be achieved without any change in fuel charge, reactor structures, and/or civil structures. The uprating may be achieved with no diminishment of safety performance.

The plant layout may include two zones, a nuclear zone and a Balance Of Plant (BOP) zone. All nuclear safety related functions may take place in the nuclear zone where the reactor and it's protective civil structures reside. In certain embodiments, no nuclear safety functions may take place in the BOP zone where the energy converter system, cooling heat rejection system (water, air, etc.), and switch yard reside. The energy conversion system residing in the BOP zone may be modular and may be initially sized at approximately 100 MWe. The energy conversion system may be uprated to approximately 200 MWe by adding a second modular system of approximately 100 MWe rating. The BOP may receive heat through one or more intermediate sodium loops from the reactor. In certain embodiments, one loop may be used in the approximately 100 MWe configuration and two loops in the approximately 200 MWe configuration. When operating an unmodified (e.g., 100 MWe system), only one loop may be required and the second loop piping may not be installed and the second loop piping in-vessel heat transport components, primary pumps and supplementary decay heat removal circuits may be blocked off by dummy components (such as IHXs, DRACS, etc.) having the same outer dimensional envelope.

The sodium cooled, metal alloy fueled, fast neutron spectrum, plant layout reactor (e.g., the systems described herein) may be of standardized, prelicensed design and may be equipped for two loop operation. The reactor may be initially configured with only one loop installed, while the second loop in-vessel component positions may be blocked off with dummy equipment, i.e., shells having the same outer dimensions. These in-vessel heat transport components may be configured as replaceable equipment supported by and withdrawable through the reactor top deck upon reactor shutdown and primary sodium cooldown to refueling temperature.

The fuel charge in the reactor may be capable of providing approximately 20 years of full power operation at a plant rating of approximately 100 MWe or approximately 10 years of full power operation at a plant rating of approximately 200 MWe. The fuel charge may remain in place after the power uprate is run at double the previous power density and is cooled by twice the coolant flow rate.

A minimum-achievable dimension of the reactor vessel may be determined by fuel handling considerations, and not by heat transport considerations. The smallest vessel diameter so determined may have surplus space for approximately 100 MWe heat transport equipment and may be large enough to accommodate approximately 200 MWe sized heat transport equipment. The vessel size may remain unaltered for power uprate.

Dimensions of the reactor's protective civil structures, e.g., containment, silo, shield building and seismic isolators, may be determined by fuel handling and replaceable heat transport component handling considerations, and not by severe accident consequence mitigation considerations. The civil structures may remain unaltered for power uprate.

Temperature margins to damaging conditions may be unchanged by power uprate and passive reactivity feedback values may remain within the range to guarantee passive safety response.

Passive decay heat removal with no reliance on BOP systems may be retained upon power uprate. Passive load follow operations, wherein the reactor self-adjusts power to match BOP heat demand and a non-nuclear safety grade BOP may be retained upon power uprate.

Severe accident phenomenology that leads to a final state characterized by in-vessel retention of a subcritical, natural circulation coolable debris bed may remain unchanged by a power uprate to approximately 200 MWe.

Although the foregoing descriptions are directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

What is claimed is:

1. A system comprising:
a previously-deployed nuclear power plant with a predetermined base power output rating and a predetermined base whole core refueling interval; and
a power upgrade kit for increasing the base power output rating from the base power output rating to an increased power output rating without a change in fuel charge, reactor structures, or civil structures.

2. The system of claim 1, wherein the previously-deployed nuclear power plant is a small modular reactor nuclear power plant.

3. The system of claim 1, wherein the predetermined base power output rating is approximately 100 MWe.

4. The system of claim 1, wherein the predetermined base whole core refueling interval is approximately 20 years.

5. The system of claim 1, wherein the increased power output rating is at least approximately double the predetermined base power output rating.

6. The system of claim 1, wherein the increased power output rating is approximately 200 MWe.

7. The system of claim 1, wherein the power upgrade kit comprises an additional energy converter system, an additional heat transport loop, one or more additional primary pumps, and one or more passive decay heat removal heat exchangers.

8. The system of claim 1, wherein the base nuclear power plant comprises a balance of plant zone and a nuclear zone, wherein all nuclear safety functions occur in the nuclear zone.

9. The system of claim 8, wherein the balance of plant zone comprises an energy converter system, a cooling heat rejection system, and a switch yard.

10. The system of claim 9, wherein the energy converter system is modular and is sized to accommodate the predetermined base power output rating.

11. The system of claim 8, wherein the balance of plant zone receives heat through intermediate sodium loops from the reactor.

12. The system of claim 11, wherein the balance of plant zone comprises one intermediate sodium loop in the base power output configuration and two intermediate sodium loops in the increased power output configuration.

13. The system of claim 11, wherein the balance of plant zone comprises one intermediate sodium loop in the base power output configuration and one dummy component having the same outer dimensional envelope as the one intermediate sodium loop.

14. A method comprising:
providing a previously-deployed nuclear power plant with a predetermined base power output rating and a predetermined base whole core refueling interval; and
providing a power upgrade kit during the predetermined base whole core refueling interval for increasing the base power output rating from the base power output rating to an increased power output rating without a change in fuel charge, reactor structures, or civil structures.

15. The method of claim 14, further comprising installing the power upgrade kit.

16. The method of claim 14, wherein the power upgrade kit comprises one or more additional heat transport components, an additional heat transport loop, one or more additional primary pumps, and one or more passive decay heat removal heat exchangers.

17. The method of claim 16, wherein the installing comprises removing one or more dummy heat transport components and installing the one or more additional heat transport component in place of the one or more dummy heat transport components.

18. The method of claim 14, wherein a minimum-achievable dimension of a reactor vessel is determined by fuel handling considerations not by heat transport considerations.

19. The method of claim 14, wherein dimensions of the civil structures is determined by fuel handling and replaceable heat transport component handling considerations not by severe accident consequence mitigation considerations.

20. The method of claim 14, wherein temperature margins to damaging conditions are unchanged by power uprate and passive reactivity feedback values remain within the range to guarantee passive safety response.

21. The method of claim 14, wherein passive decay heat removal with no reliance on balance of plant systems is retained upon power uprate.

22. The method of claim 14, wherein severe accident phenomenology leads to a final state characterized by in-vessel retention of a subcritical, natural circulation coolable debris bed remains unchanged by a power uprate.
